(19) United States
(12) Patent Application Publication
(10) Pub. No.: US 2003/0125457 A1
(43) Pub. Date: Jul. 3, 2003

(54) Protective layer for painted surfaces

(76) Inventors: Markus A. Schafheutle, Graz (AT); Julius Burkl, Graz (AT)

Correspondence Address: ProPat, L.L.C., 2912 Crosby Road, Charlotte, NC, 28211-2815, US

(21) Appl. No.: 10/327,780

(22) Filed: Dec. 23, 2002

(30) Foreign Application Priority Data
Jan. 2, 2002 (AT) A 9/2002

(51) Int. Cl. C08K 3/00

(52) U.S. Cl. 524/589; 524/800

(57) ABSTRACT

An aqueous dispersion comprising a high molar mass polyurethane A and additives B, wherein the polyurethane has a number-average molar mass of at least 10 kg/mol and a weight-average molar mass of at least 20 kg/mol and wherein the additives B contain mercaptan groups, hydrazide groups and/or N-alkylamide groups, their preparation, and their use as a surface protection coating, especially for motor vehicles.

### FIELD OF THE INVENTION

The invention relates to a protective layer for painted surfaces and to a method of applying it.

### BACKGROUND OF THE INVENTION

Following their production, motor vehicles are provided with a surface protection which is intended to protect the finish of the vehicle against aggressive environmental effects up until the time it is delivered to the customer. Those motor vehicles in particular which are produced for stock rather than to specific customer order may stand for up to several months prior to delivery, and so here surface protection is indispensable. A surface protection of this kind is normally applied only to the paint and not to the windows, the substantially horizontal surfaces of the vehicle in particular being the focus of protection. The windows are left exposed so that the vehicle remains driveable and so, for example, can be freighted or else run back to production in order to complete its equipping (mounted components).

For this purpose it is common to use wax preservatives, although these necessitate the use of a solvent. One alternative is a protective sheet, but this not only involves relatively expensive material but must also be applied, laboriously, by hand, meaning that the overall costs of the surface protection are considerable.

For the temporary protection of newly produced and freshly painted motor vehicles it is of particular importance that the surface protection, first, does not attack the paint film during application or soon afterward; secondly, is not impossible to remove or is not removable only with undue force, owing to excessive adhesion; and, thirdly, does not spoil the paint film during its removal.

It is an object of the present invention, therefore, to provide a surface protection layer for painted and unpainted surfaces, especially for motor vehicles, which is quick to apply and easy to remove without damaging the substrate and which does not involve the use of considerable quantities of solvent.

This object is achieved by means of an aqueous dispersion of special, high molar mass polyurethanes with special additives.

### SUMMARY OF THE INVENTION

The present invention accordingly provides an aqueous dispersion comprising a high molar mass polyurethane A and also additives B selected from mercaptans, hydrazides, and N-alkylamides.

Particularly suitable additives B of this kind contain two of the reactive groups mentioned; that is, two groups selected from hydrazide groups, mercaptan groups, and N-alkylamide groups. It is preferred for one molecule to contain two identical reactive groups, viz dihydrazides, dimercaptans, and bis(N-alkylamides).

### DETAILED DESCRIPTION OF THE PREFERRED EMBODIMENTS

The high molar mass polyurethanes A have a number-average molar mass Mₙ (measured by gel permeation chromatography, calibrating with polystyrene standards) of at least 10 kg/mol, preferably at least 15, and with particular preference at least 20 kg/mol, and a weight-average molar mass M_{w} of at least 20 kg/mol, preferably at least 30 and with particular preference at least 40 kg/mol. The acid number of the polyurethanes A, defined in accordance with DIN 53 402 as the ratio of that mass m_{KOH} of potassium hydroxide required to neutralize a sample under test to the mass m_{B} of this sample (mass of the solid in the sample in the case of solutions or dispersions), is preferably from 20 to 50 mg/g, in particular from 25 to 45 mg/g.

The polyurethane A contains units derived from polyisocyanates AA, polyols AB having a number-average molar mass Mₙ of at least 400 g/mol, where appropriate, low molar mass polyols AC with Mₙ of less than 400 g/mol, compounds AD which contain at least two isocyanate-reactive groups and at least one group capable of forming anions, low molar mass polyols AE, which carry no further isocyanate-reactive groups, compounds AF, which are monofunctional with respect to isocyanates or contain active hydrogen of different reactivity and are different from the compounds AE, and also, where appropriate, compounds AG, which are different from AB, AC, AD, AE, and AF and contain at least two NCO-reactive groups. Preferably, the polyurethane is free from carbonyl groups which stem from ketone or aldehyde functionalities. In another preferred embodiment, the polyurethane A comprises a mass fraction of less than 5%, preferably less than 2%, and particularly preferably less than 1% of moieties of vinyl polymers. It is especially preferred that the polyurethane A is completely devoid of such vinyl moieties.

Especially good results are obtained when the number-average molar mass of the polyurethane resin A is at least 25 kg/mol.

The high molar mass, water-dispersible polyurethane resins are prepared by the following steps:

synthesis of isocyanate-functional prepolymer by reaction of polyisocyanates AA with polyols AB having a number-average molar mass Mₙ of at least 400, where appropriate low molar mass polyols AC, and compounds AD which contain at least two isocyanate-reactive groups and at least one group capable of forming anions, to give a prepolymer which contains free NCO groups and has a Staudinger index J₀ of at least 20 cm³/g, preferably at least 23 cm³/g, and with particular preference at least 26 cm³/g,

at least partial neutralization of the group in the compound AD that is capable of forming anions, to form anionic groups, dispersion of this prepolymer in water, and

reaction of the neutralized prepolymer with at least one of the components selected from low molecular weight polyols AE which carry no further isocyanate-reactive groups, these compounds being employed in excess, compounds AF, which are monofunctional with respect to isocyanates or contain active hydrogen of different reactivity and are different from the compounds AE, and also, where appropriate, compounds AG, which are different from AB, AC, AD, AE, and AF and contain at least two NCO-reactive groups.

The Staudinger index of the prepolymer formed in step 1, measured in N-methylpyrrolidone/chloroform as solvent, may in particular exhibit values which are even higher than those stated above. Especially good properties, particularly in respect of the initial drying rate of the surface protector coating material formulated using the prepolymer, are in fact obtained when J₀ is at least 30 cm³/g, preferably at least 33 cm³/g, and in particular at least 35 cm³/g. The formerly so-called “limiting viscosity number”, called “Staudinger index” J₀ in accordance with DIN 1342, part 2.4, is the limiting value of the Staudinger function Jᵥ at decreasing concentration and shear stress, Jᵥ being the relative change in viscosity based on the mass concentration β_{B}=m_{B}/V of the dissolved substance B (with the mass m_{B} of the substance in the volume V of the solution), i.e., Jᵥ=(ηᵣ−1)/β_{B}. Here, ηᵣ1 −is the relative change in viscosity, in accordance with the equation ηᵣ−1=(η−ηₛ)/ηₛ. The relative viscosity ηᵣ is the ratio of the viscosity η of the solution under analysis to the viscosity ηₛ of the pure solvent. (The physical definition of the Staudinger index is that of a specific hydrodynamic volume of the solvated polymer coil at infinite dilution and in the state of rest.) The unit commonly used for J is “cm³/g”; frequently also “ml/g” or “dl/g”.

The polyisocyanates AA are at least difunctional and may be selected from the group consisting of aromatic and aliphatic linear, cyclic, and branched isocyanates, especially diisocyanates. Where aromatic isocyanates are used, they must be employed in a mixture with the stated aliphatic isocyanates. The fraction of the aromatic isocyanates is to be chosen such that the number of isocyanate groups they introduce into the mixture is at least 5% less than the number of isocyanate groups which remain in the resulting prepolymer after the first stage. Preference is given to diisocyanates, in which case it is possible for up to 5% of their mass to be replaced by isocyanates with a functionality of three or more.

The diisocyanates preferably possess the formula Q(NCO)₂, in which Q stands for a hydrocarbon radical having from 4 to 40 carbon atoms, in particular from 4 to 20 carbon atoms, and preferably denotes an aliphatic hydrocarbon radical having from 4 to 12 carbon atoms, a cyclo-aliphatic hydrocarbon radical having from 6 to 15 carbon atoms, an aromatic hydrocarbon radical having from 6 to 15 carbon atoms or an araliphatic hydrocarbon radical having from 7 to 15 carbon atoms. Examples of such diisocyanates which can be used with preference are tetramethylene diisocyanate, hexamethylene diisocyanate, dodecamethylene diisocyanate, 1,4-diisocyanatocyclohexane, 3-isocyanatomethyl-3,5,5-trimethylcyclohexyl isocyanate (isophorone diisocyanate, IPDI), 4,4′-diisocyanatodicyclohexylmethane, 4,4′-diisocyanato-dicyclo-hexylpropane-(2,2), 1,4-diisocyanatobenzene, 2,4- or 2,6-diisocyanatotoluene or mixtures of these isomers, 4,4′- or 2,4′-diisocyanatodiphenylmethane, 4,4′-diisocyanato-diphenylpropane-(2,2), p-xylylene diisocyanate, and α,α,α′,α′-tetramethyl-m- or -p-xylylene diisocyanate, and mixtures of these compounds.

As well as these simple polyisocyanates, suitable polyisocyanates include those which contain heteroatoms in the radical linking the isocyanate groups. Examples thereof are polyisocyanates containing carbodiimide groups, allophanate groups, isocyanurate groups, urethane groups, acylated urea groups or biuret groups. For further suitable polyisocyanates, refer for example to DE-A 29 28 552.

Also suitable are “paint polyisocyanates” based on hexamethylene diisocyanate or on 1-isocyanato-3,3,5-trimethyl-4-isocyanatomethylcyclohexane (IPDI) and/or bis-(isocyanatocyclohexyl)methane, especially those based exclusively on hexamethylene diisocyanate. “Paint polyisocyanates” on the basis of these diisocyanates are those derivatives of these diisocyanates that are known per se and contain biuret, urethane, uretdione and/or isocyanurate groups and that, following their preparation, have been freed where appropriate from excess starting diisocyanate in a known way, preferably by distillation, down to a residual mass fraction of less than 0.5%. The preferred aliphatic polyisocyanates for use in accordance with the invention include polyisocyanates which meet the above criteria, contain biuret groups, and are based on hexamethylene diisocyanate, such as may be obtained, for example, by the processes of U.S. Pat. Nos. 3,124,605, 3,358,010, 3,903,126, 3,903,127 or 3,976,622, which are composed of mixtures of N,N,N-tris-(6-isocyanatohexyl) biuret with minor amounts of its higher homologs, and also the cyclic trimers of hexamethylene diisocyanate which meet the stated criteria and can be obtained in accordance with U.S. Pat. No. 4,324,879, and which are composed essentially of N,N,N-tris(6-isocyanatohexyl) isocyanurate in a mixture with minor amounts of its higher homologs. Particular preference is given to mixtures of polyisocyanates which meet the stated criteria, contain uretdione and/or isocyanurate groups, and are based on hexamethylene diisocyanate, such as are formed by catalytic oligomerization of hexamethylene diisocyanate using trialkylphosphanes. Particular preference is given to the last-mentioned mixtures with a viscosity at 23° C. of from 50 to 20 000 mPa.s and an NCO functionality of between 2.0 and 5.0.

The aromatic polyisocyanates which are likewise suitable in accordance with the invention but are preferably to be used in a mixture with the abovementioned aliphatic polyisocynates include in particular “paint polyisocyanates” based on 2,4-diisocyanatotoluene or its technical-grade mixtures with 2,6-diisocyanatotoluene or on 4,4-diisocyanatodiphenylmethane and/or its mixtures with its isomers and/or higher homologs. Aromatic paint polyisocyanates of this kind are, for example, the isocyanates which contain urethane groups, such as are obtained by reacting excess amounts of 2,4-diisocyanatotoluene with polyhydric alcohols such as trimethylolpropane and then where appropriate removing the unreacted diisocyanate excess by distillation. Examples of further aromatic paint polyisocyanates are the trimers of the monomeric diisocyanates exemplified, i.e., the corresponding isocyanato-isocyanurates, which following their preparation may have been freed, preferably by distillation, from excess monomeric diisocyanates. In the mixtures of aromatic and (cyclo)aliphatic isocyanates, the amounts of these two components are chosen such as to ensure that the isocyanate groups of the prepolymer are exclusively or at least 90% (cyclo)aliphatically attached.

The polyisocyanate component AA may further be composed of any desired mixtures of the polyisocyanates exemplified.

The mass fraction of building blocks derived from the polyisocyanates AA in the polyurethane resin is generally from about 10 to 50%, preferably from 20 to 35%, based on the mass of the polyurethane resin.

The polyols AB preferably possess a number-average molar mass Mₙ of from 400 to 5,000 g/mol, in particular from 800 to 2,000 g/mol. Their hydroxyl number is generally from 30 to 280, preferably from 40 to 200, and in particular from 50 to 160 mg/g. It is preferred to use exclusively difunctional polyols AB; however, up to 5% of the mass of the polyols AB may also be replaced by polyols with a functionality of three or more.

The hydroxyl number is defined in accordance with DIN 53 240 as the ratio of the mass m_{KOH} of potassium hydroxide which has exactly the same number of hydroxyl groups as a sample under analysis to the mass m_{B} of that sample (mass of the solid in the sample in the case of solutions or dispersions); its customary unit is “mg/g”.

Examples of such polyols, which are the compounds known from polyurethane chemistry, are polyether polyols, polyester polyols, polycarbonate polyols, polyesteramide polyols, polyamidoamide polyols, epoxy resin polyols and their reaction products with CO₂, polyacrylate polyols, and the like. Polyols of this kind, which may also be used as a mixture, are described, for example, in the laid-open DE specifications 20 20 905, 23 14 513, and 31 24 784, and also in EP-A 0 120 466. It is likewise possible to use castor oil as a polyol component.

Of these polyols, preference is given to the polyether and polyester polyols, especially those which contain only terminal OH groups and possess a functionality of less than 3, preferably of from 2.8 to 2, and in particular of 2.

Examples of polyether polyols here include polyoxyethylene polyols, polyoxypropylene polyols, polyoxybutylene polyols, mixed and block copolymers of these, and, preferably, polytetrahydrofurans containing terminal OH groups.

The polyester polyols which are particularly preferred in accordance with the invention are the known polycondensates of organic dihydroxy and also, where appropriate, polyhydroxy (trihydroxy, tetrahydroxy) compounds and dicarboxylic and also, where appropriate, polycarboxylic (tricarboxylic, tetracarboxylic) acids or hydroxy carboxylic acids or lactones. Instead of the free polycarboxylic acids it is also possible to use the corresponding polycarboxylic anhydrides or corresponding polycarboxylic esters of lower alcohols to prepare the polyesters. Examples of suitable diols are ethylene glycol, 1,2-butanediol, diethylene glycol, triethylene glycol, polyalkylene glycols, such as polyethylene glycol, and also 1,2- and 1,3-propanediol, 1,4-butanediol, 1,6-hexanediol, neopentyl glycol or neopentyl glycol hydroxypivalate. As polyols which may be employed additionally, having three or more hydroxyl groups in the molecule, examples to be mentioned here include trimethylolpropane, trimethylolethane, glycerol, erythritol, pentaerythritol, ditrimethylolpropane, dipentaerythritol, trimethylolbenzene or trishydroxyethyl isocyanurate.

Suitable dicarboxylic acids include aromatic and cycloaliphatic dicarboxylic acids, linear and branched alkyl- and alkenyl-dicarboxylic acids, and dimeric fatty acids. The following are suitable examples: phthalic acid, isophthalic acid, terephthalic acid, tetrahydrophthalic acid, hexahydrophthalic acid, 1,4-cyclohexanedicarboxylic acid, adipic acid, succinic acid, azelaic acid, sebacic acid, glutaric acid, “Chlorendic” acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid, octenylsuccinic acid and dodecenylsuccinic acid. Anhydrides of these acids can likewise be used where they exist. The anhydrides are embraced here by the term “acid”. It is also possible to use minor amounts (mole fraction up to 10%, based on the amount of substance of all acids) of monocarboxylic acids, such as benzoic acid and hexanecarboxylic acid. Saturated aliphatic or aromatic acids are preferred, such as adipic acid or isophthalic acid. As polycarboxylic acids to be used where appropriate in relatively small amounts, mention may be made here of trimellitic acid, trimesic acid, pyromellitic acid, and also polyanhydrides, as described in DE 28 11 913, or mixtures of two or more of such compounds.

The hydroxy carboxylic acids, which can be used as coreactants in the preparation of a polyester polyol containing terminal hydroxyl groups, are, for example, hydroxycaproic acid, and hydroxybutyric acid, hydroxydecanoic acid, hydroxystearic acid. Lactones which can be used in the synthesis of the polyester polyols include caprolactone, butyrolactone, and valerolactone.

The mass fraction of building blocks derived from component AB in the polyurethane resin is customarily between 15 and 80%, preferably between 40 and 60%, based on the mass of the polyurethane resin.

The low molar mass polyols AC which are used where appropriate for synthesizing the polyurethane resins have the general effect of stiffening the polymer chain. They generally possess a molar mass of from about 60 to 400 g/mol, preferably from 60 to 200 g/mol, and hydroxyl numbers of from 200 to 1500 mg/g. They may contain aliphatic, alicyclic or aromatic groups. Their mass fraction, where used, is generally from 0.5 to 20%, preferably from 1 to 10%, based on the mass of the hydroxyl-containing components AB to AD. Suitable, for example, are the low molar mass polyols having up to about 20 carbon atoms per molecule, examples being ethylene glycol, diethylene glycol, 1,2-propanediol, 1,3-propanediol, 1,4-butanediol, 1,2- and 1,3-butylene glycol, 1,2- and 1,4-cyclohexanediol, 1,4-cyclohexanedimethanol, 1,6-hexanediol, bisphenol A (2,2-bis(4-hydroxyphenyl)propane), hydrogenated bisphenol A (2,2-bis-(4-hydroxycyclohexyl)propane) and mixtures thereof, and also, as triols, trimethylolethane and trimethylolpropane. It is preferred to use exclusively or at least predominantly (generally more than 90% of the mass, preferably more than 95%) diols.

Where compounds with a functionality of three or more are used as compounds AA, AB and/or AC, it should be ensured when synthesizing the prepolymer that no gelling occurs. This can be prevented, for example, by using monofunctional compounds together with the trifunctional or higher polyfunctional compounds, the amount of the monofunctional compounds in that case being chosen preferably such that the average functionality of the component in question does not exceed 2.3, preferably 2.2, and in particular 2.1.

The anionogenic compounds AD contain at least one and preferably at least two isocyanate-reactive groups such as hydroxyl, amino, and mercaptan groups and at least one acid group which forms anions on at least partial neutralization in aqueous solution or dispersion. Such compounds are described, for example, in U.S. Pat. Nos. 3,412,054 and 3,640,924 and also in the laid-open DE specifications 26 24 442 and 27 44 544, hereby incorporated by reference. Particularly suitable for this purpose are polyols, preferably diols, which contain at least one carboxyl group, generally from 1 to 3 carboxyl groups, per molecule. Other groups capable of forming anions suitably include sulfonic acid groups and phosphonic acid groups. Particular examples of compounds AD are dihydroxy carboxylic acids, such as α,α-dialkylolalkanoic acids, especially α,α-dimethylolalkanoic acids such as 2,2-dimethylolacetic acid, 2,2-dimethylolpropionic acid, 2,2-dimethylolbutyric acid, 2,2-dimethylolpentanoic acid, and the isomeric tartaric acids, and also polyhydroxy acids such as gluconic acid. Particularly preferred in this context is 2,2-dimethylolpropionic acid. Examples of amino-containing compounds AD are 2,5-diaminovaleric acid (ornithine) and 2,4-diaminotoluene-5-sulfonic acid. It is also possible to employ mixtures of the compounds AD mentioned. The mass fraction of building blocks derived from component AD in the polyurethane resin is generally from 2 to 20%, preferably from 4 to 10%, based on the mass of polyurethane resin.

The compounds AE are located predominantly, preferably at from 70 to 90%, at the ends of each of the molecule chains, which they terminate (chain terminators). Suitable polyols are also of low molar mass (Mₙ as in component AC) and possess at least three, preferably three or four, hydroxyl groups in the molecule. Examples that may be mentioned here include glycerol, hexanetriol, pentaerythritol, dipentaerythritol, diglyerol, trimethylolethane and trimethylolpropane, the latter being preferred. As a chain terminator, component AE is used in excess, in other words in an amount such that the number of hydroxyl groups in the amount of component AE used exceeds that of the isocyanate groups still present in the prepolymer made of AA, AB, AC, and AD. The mass fraction of building blocks derived from component AE in the polyurethane resin is customarily between 2 and 15%, preferably from 5 to 15%, based on the mass of the polyurethane resin. Where appropriate, building blocks derived from component AE are present in the polyurethane resin in a mixture with the building blocks derived from AF and/or AG.

The compounds AF are monofunctional compounds which are reactive with NCO groups, such as monoamines, especially mono-secondary amines, or monoalcohols. Examples that may be mentioned here include the following: methylamine, ethylamine, n-propylamine, n-butylamine, n-octylamine, laurylamine, stearylamine, isononyloxypropylamine, dimethylamine, diethylamine, di-n- and di-isopropylamine, di-n-butylamine, N-methylaminopropylamine, diethyl- and dimethylaminopropylamine, morpholine, piperidine, and suitably substituted derivatives thereof, amidoamines formed from diprimary amines and monocarboxylic acids, and monoketimines of diprimary amines, and primary/tertiary amines, such as N,N-dimethylaminopropylamine.

Suitable compounds AF preferably include those containing active hydrogen with a reactivity which differs with respect to NCO groups, especially compounds which contain not only a primary amino group but also secondary amino groups, or which contain not only an OH group but also COOH groups or not only an amino group (primary or secondary) but also OH groups, the latter being particularly preferred. Examples of such compounds include the following: primary/secondary amines, such as 3-amino-1-methylaminopropane, 3-amino-1-ethylaminopropane, 3-amino-1-cyclohexylaminopropane, 3-amino-1-methylaminobutane; monohydroxy carboxylic acids, such as hydroxyacetic acid, lactic acid or malic acid, and also alkanolamines such as N-aminoethylethanolamine, ethanolamine, 3-aminopropanol, neopentanolamine, and, with particular preference, diethanolamine.

As in the case of compounds AE, it is possible in this way to introduce additional functional groups into the polymeric end product and so to make this product more reactive toward materials, such as curatives, if desired. The mass fraction of building blocks derived from component AF in the polyurethane resin is customarily between 2 and 20%, preferably 3 and 10%, based on the mass of the polyurethane resin.

The compounds AG are the so-called chain extenders. Suitable such compounds include the NCO-reactive and preferably difunctional compounds which are known for this purpose, which are not identical with AB, AC, AD, AE, and AF, and which normally have number-average molar masses of up to 400 g/mol. Examples that may be mentioned here include water, hydrazine, dihydrazides of dicarboxylic acids such as adipic dihydrazide, diamines such as ethylenediamine, 1,3-diaminopropane, 1,4-diaminobutane, and hexamethylenediamine, it being possible for the amines to carry substituents as well, such as OH groups. Such polyamines are described, for example, in the laid-open DE specification 36 44 371. The mass fraction of building blocks derived from component AG in the polyurethane resin is customarily between 1 and 10%, preferably 2 and 5%, based on the mass of the polyurethane resin.

The additives B have the effect, surprisingly, that the coating film which remains when the dispersion medium (water) evaporates can be detached without great force by pulling. Where these additives are omitted while the formulation is otherwise the same, it has been found that the surface protection film can no longer be removed.

Suitable additives B are, in particular, hydrazides of monocarboxylic acids selected from linear, branched, and cyclic alkanoic acids and also aromatic monocarboxylic acids, and dihydrazides of alkanedioic acids and aromatic dicarboxylic acids having in each case from 2 to 40 carbon atoms, alkyl mercaptans and dimercaptoalkanes having from 2 to 20 carbon atoms in the alkyl or alkylene radical, respectively, and also N-alkylamides of linear, branched and cyclic alkanoic acids and also aromatic monocarboxylic acids, and bis-N-alkylamides of alkanedioic acids and aromatic dicarboxylic acids having in each case from 2 to 40 carbon atoms in the acid radical and from 1 to 6, preferably from 1 to 4, carbon atoms in the N-alkyl radical. Particularly suitable additives B are the dihydrazides of succinic acid, glutaric acid, adipic acid, pimelic acid, phthalic acid, isophthalic acid, and terephthalic acid, N-methylacetamide, N-methylpropionamide, and the bis(N-methylamides) of oxalic acid, succinic acid, glutaric acid, adipic acid, pimelic acid, phthalic acid, isophthalic acid and terephthalic acid.

The invention also provides a method of protecting the surface of metals or painted surfaces by applying to a substrate a layer of the aqueous dispersion of the invention. For the application of the surface protection layer of the invention, a painted bodywork in particular, especially a motor vehicle which is completely finished or substantially completely finished at least externally, is treated with the aqueous dispersion comprising the polyurethane A and the additive B, the dispersion being used in particular to wet substantially the horizontal surfaces. The dispersion solidifies on the painted bodywork; that is, at least part of the dispersion remains as a solid coating in the manner of a film, it being possible for another part of the dispersion (essentially water) to evaporate.

The dispersion is applied to the motor vehicle normally by spraying, although it may also be applied by brushing. In the case of spraying, the spraying device is preferably directed onto the vehicle in such a way that the windows of the vehicle are predominantly not sprayed. In addition, the dispersion may be applied restrictedly or not at all to the predominantly vertical surfaces of the vehicle. The dispersion is applied advantageously such that the resulting layer has a thickness substantially in the range from 10 μm to 1000 μm, in particular from 20 μm to 500 mm, and with particular advantage from 20 μm to 100 mm. Following its removal from the surface being protected, the film can be passed on for customary plastics recycling/recovery.

With the invention, the preservation of motor vehicles is made more environmentally compatible (solvent-free), the preservative being stable to cold water (showerproof), exhibiting good compatibility with the paint, possessing sufficient adhesion (not being detached by the wind during transport), being stable for several months (in particular from 2 to 12), and being readily removable. Moreover, the surface protection layer of the invention entails low manufacturing costs and requires only short manufacturing times.

The following examples illustrate the invention.

### EXAMPLE 1

### Preparation of a Polyester-diol

132 g of adipic acid, 72 g of isophthalic acid, 142 g of 1,6-hexanediol and 42 g of neopentyl glycol were charged to a 1 1 round-bottomed glass flask and slowly heated to 250° C. with distillative removal of the water of reaction. The mixture was held at this temperature until the acid number had fallen below 10 mg/g. Condensation was then continued under reduced pressure until the acid number fell below 2 mg/g. This gave a clear polyester having a hydroxyl number of from 75 to 80 mg/g.

### EXAMPLE 2

### Solvent-free PU Dispersion; High Temperature

213 g of the polyester from Example 1, 1.3 g of ethylene glycol, 26.8 g of dimethylolpropionic acid and 8.3 g of neopentyl glycol were mixed in 150 g of methyl isobutyl ketone at about 60° C. 119 g of isophorone diisocyanate were added to this mixture, which was heated to from 100 to 120° C. It was held at this temperature until a Staudinger index (“limiting viscosity”) of from 28 to 30 cm³/g had been reached (after about 4.5 h). The solution was then cooled to 95° C. and 12.6 g of triethylamine were added. Following homogenization, the solution was dispersed using 808 g of deionized water with a temperature of about 80° C. Immediately thereafter a solution of 3.1 g of ethylenediamine in 100 g of deionized water was added. After a holding time of 30 minutes at 80° C., 337 g of a mixture of methyl isobutyl ketone and water were distilled off under slightly reduced pressure. Cooling gave a fine dispersion having a nonvolatile fraction (mass fraction of solids) of 34%, a viscosity of 500 to 1000 mPa.s, and a pH of about 8.1.

### EXAMPLE 3

### Solvent-free Branched PU Dispersion; High Temperature

213g of the polyester from Example 1, 1.3 g of ethylene glycol, 26.8 g of dimethylolpropionic acid and 8.3 g of neopentyl glycol were mixed in 150 g of methyl isobutyl ketone at about 60° C. 119 g of isophorone diisocyanate were added to this mixture, which was heated to from 100 to 120° C. It was held at this temperature until a Staudinger index (“limiting viscosity”) of from 28 to 30 cm³/g had been reached (after about 4.5 h). The solution was then cooled to 95° C. and 12.6 g of triethylamine were added. Following homogenization, the solution was dispersed using 808 g of deionized water with a temperature of about 80° C. Immediately thereafter a solution of 3.8 g of triethylenetetramine in 100 g of deionized water was added. After a holding time of 30 minutes at 80° C., 337 g of a mixture of methyl isobutyl ketone and water were distilled off under slightly reduced pressure. Cooling gave a fine dispersion having a nonvolatile fraction (mass fraction of solids) of 34%, a viscosity of 500 to 1000 mPa.s, and a pH of about 8.1.

### EXAMPLE 4

### Solvent-free Branched PU Dispersion; Low Temperature

302.3 g of polybutadienediol (®PolyBD R45HT, ElfAtochem) were charged to a 2 L glass flask and dissolved in 340 g of methyl ethyl ketone (MEK). 9.5 g of triethylamine and 17.9 g of dimethylolpropionic acid were added to this mixture and dissolved. The mixture was heated to 70° C. At this temperature, 89.9 g of isophorone diisocyanate were added to the clear solution. The mixture underwent an increase in temperature to 80° C. This temperature was maintained until the Staudinger index (“limiting viscosity”) of the polyurethane had reached 24.5 cm³/g. When this figure had been reached, the resin solution was dispersed over the course of from 5 to 10 minutes using 708 g of water which had been heated to 80° C. beforehand. During dispersion, distillative removal of the MEK/water azeotrope formed was commenced. Immediately after the end of the addition of water, a solution consisting of 6.8 g of ethylenediamine in 60 g of water was metered in over the course of 5 minutes. Heat was produced and the temperature rose by about 3 to 4° C., thereby strongly promoting the distillation of the azeotrope. The distillation was subsequently continued, with gentle additional heating, until a total of 340 g of MEK and 360 g of water had been distilled off. Cooling to room temperature gave a whitishly opaque dispersion having a mass fraction of solids of 50% and a viscosity of about 500 to 1000 mPa.s. The pH of this dispersion was about 7.5.

### EXAMPLE 5

### Surface Protection Coating Formulations with Adipic Dihydrazide (ADH) as Additive

The polyurethanes from Examples 2 to 4 were used to produce surface protection coating materials. The formulation of the surface protection coating material with the additive of the invention was in accordance with Table 1 below.

TABLE 1
Masses of the components in g

| | |
|---|---|
| 68 | PU dispersions from Ex. 2 to 4 adjusted to a |
| | nonvolatile fraction of 35% |
| 5 | ® Additol VXW 6200/10% in water |
| 1 | ® Additol VXW 6208 |
| 0.5 | ® Byk 346 |
| 7.5 | Water |
| 1 | Defoamer DNE |
| 16.60 | ® Kronos 2310 |
| 0.40 | ADH |
| 100 | |

| | |
|---|---|
| Defoamer DNE: | mixture of fatty acid esters and |
| | paraffins with carboxylates; Bayer |
| | AG, Leverkusen |
| Additol VXW 6200: | anionic polymeric dispersing |
| | additive, Solutia Austria GmbH |
| Additol VXW 6208: | nonionic polymeric dispersing |
| | additive, Solutia Austria GmbH |
| Kronos 2310: | titanium dioxide pigment |
| Byk 346: | silicone surfactant, polyether- |
| | modified polydimethylsiloxane, |
| | Byk-Chemie GmbH, Wesel |

The coating material was prepared in a bead mill; a mass fraction of solids in the coating material of about 40% was obtained, with the ratio of the masses of binder and pigment being 1:0.7.

### EXAMPLE 6

### Surface Protection Coating Formulations without Adipic Dihydrazide (ADH)

The polyurethanes from Examples 2 to 4 were used to produce surface protection coating materials. The formulation of the surface protection coating material without the additive of the invention was in accordance with Table 2 below.

TABLE 2
Masses of the components in g

| | |
|---|---|
| 68 | PU dispersions from Ex. 2 to 4 adjusted to a |
| | nonvolatile fraction of 35% |
| 5 | ® Additol VXW 6200/10% in water |
| 1 | ® Additol VXW 6208 |
| 0.5 | ® Byk 346 |
| 7.9 | Water |
| 1 | Defoamer DNE |
| 16.6 | ® Kronos 2310 |
| 100 | |

The coating material was prepared in a bead mill; a mass fraction of solids in the coating material of about 40% was obtained, with the ratio of the masses of binder and pigment being 1:0.7.

### EXAMPLE 7

### Test Results

The coating materials of Examples 5 and 6 were applied by spraying, 20 minutes after leaving the oven, to an automobile body with a freshly applied, isocyanate-curing, 2K acrylic clearcoat cured at 80° C. for 30 minutes. The paint system was subsequently cured at 80° C. for 3 hours and conditioned. Testing was carried out after a further period of rest of 16 hours at room temperature. The test results are summarized in Table 3.

TABLE 3
test results

| | | | Resistance | |
|---|---|---|---|---|
| | | | to | |
| | | | combined | |
| PU dispersions | Tear | | heat and | Solvent |
| from | strength^{#} | Removability⁺ | moisture* | resistance^{&} |
| Ex. 2 + 5 | 1 | 5 | 1 | 4 |
| Ex. 2 + 6 | 1 | 1 | 1 | 4 |
| Ex. 3 + 5 | 2 | 5 | 2 | 2 |
| Ex. 3 + 6 | 2 | 1 | 2 | 2 |
| Ex. 4 + 5 | 5 | 5 | 1 | 1 |
| Ex. 4 + 6 | 5 | 1 | 1 | 1 |

^{#}ranking as below
⁺from clearcoat as described
*after 10 days' storage at 40° C. and 100% relative humidity
^{&}measured on storage in a 1:1 isopropanol:water mixture at 40° C. for 30 minutes
Ranking: 1 = very good, 5 = poor

What is claimed is:

1. An aqueous dispersion comprising a high molar mass polyurethane A and additives B, wherein the polyurethane has a number-average molar mass of at least 10 kg/mol and a weight-average molar mass of at least 20 kg/mol and wherein the additives B contain mercaptan groups, hydrazide groups and/or N-alkylamide groups.

2. The aqueous dispersion as claimed in claim 1, wherein the polyurethane A has an acid number of from 20 to 50 mg/g.

3. The aqueous dispersion as claimed in claim 1, wherein the polyurethane A contains units derived from polyisocyanates AA, polyols AB having a number-average molar mass Mₙ of at least 400 g/mol, where appropriate, low molar mass polyols AC with Mₙ of less than 400 g/mol, compounds AD which contain at least two isocyanate-reactive groups and at least one group capable of forming anions, low molar mass polyols AE, which carry no further isocyanate-reactive groups, compounds AF, which are monofunctional with respect to isocyanates or contain active hydrogen of different reactivity and are different from the compounds AE, and also, where appropriate, compounds AG, which are different from AB, AC, AD, AE, and AF and contain at least two NCO-reactive groups.

4. The aqueous dispersion as claimed in claim 1, wherein the additives B are hydrazides of monocarboxylic acids or dihydrazides of dicarboxylic acids having in each case from 2 to 40 carbon atoms.

5. The aqueous dispersion as claimed in claim 1, wherein the additives B are N-alkylamides of monocarboxylic acids or bis(N-alkylamides) of dicarboxylic acids having in each case from 2 to 40 carbon atoms in the acid radical and from 1 to 6 carbon atoms in the N-alkyl radical.

6. The aqueous dispersion as claimed in claim 1, wherein adipic dihydrazide is used as additive B.

7. The aqueous dispersion as claimed in claim 1, wherein N-methylacetamide is used as additive B.

8. A process for preparing an aqueous dispersion as claimed in claim 1, which comprises
in a first step preparing an isocyanate-functional prepolymer by reaction of polyisocyanates AA with polyols AB having a number-average molar mass Mₙ of at least 400, where appropriate low molar mass polyols AC, and compounds AD which contain at least two isocyanate-reactive groups and at least one group capable of forming anions, to give a prepolymer which contains free NCO groups and has a Staudinger index J₀ of at least 20 cm³/g,
in a second step at least partly neutralizing the group in the compound AD that is capable of forming anions, to form anionic groups, dispersing this prepolymer in water, and
in a third step reacting the neutralized prepolymer with at least one of the components selected from low molecular weight polyols AE which carry no further isocyanate-reactive groups, these compounds being employed in excess, compounds AF, which are monofunctional with respect to isocyanates or contain active hydrogen of different reactivity and are different from the compounds AE, and also, where appropriate, compounds AG, which are different from AB, AC, AD, AE, and AF and contain at least two NCO-reactive groups.

9. The use of an aqueous dispersion as claimed in claim 1 for producing surface protection coatings on painted and unpainted metals.

10. The use of an aqueous dispersion as claimed in claim 1 for producing surface protection coatings on automobiles.
